(19) United States
(12) Patent Application Publication
(10) Pub. No.: US 2012/0213935 A1
(43) Pub. Date: Aug. 23, 2012

(54) SOL GEL PROCESS FOR PRODUCING PROTECTIVE FILMS FOR POLYMERIC SUBSTRATES

(75) Inventors: Daniele FREGONESE, Vigonovo (VE) (IT); Fulvio COSTA, Sommo (IT)

(73) Assignee: Evonik Degussa GmbH, Essen (DE)

(21) Appl. No.: 13/457,890

(22) Filed: Apr. 27, 2012

Related U.S. Application Data
(63) Continuation of application No. 12/519,765, filed on Jun. 18, 2009, now abandoned.

(30) Foreign Application Priority Data
Dec. 19, 2006 (EP) 06126485.9

(51) Int. Cl. B05D 3/00

(52) U.S. Cl. 427/387

(57) ABSTRACT

Sol gel process for producing hydrophobic transparent films for polymeric substrates, the process relates to the sol-gel reaction of silicon alkoxide carried out in certain conditions. The sols obtained were, without limiting, spin- or dip-coated onto polymeric substrates then thermally cured into transparent-abrasion resistant coating. Such coating transmit visible light, but absorb wavelengths of ultraviolet light which cause degradation of the substrate surface and resultant adhesion-loss of the protective coating upon weathering.

The present application is a continuation of U.S. Ser. No. 12/519,765, filed Jun. 18, 2009, which is a National Stage (371) of PCT/EP2007/064191, filed Dec. 19, 2007, and claims priority to EP 06126485.9, filed Dec. 19, 2006.

The subject of the invention is a process for the preparation of hydrophobic transparent films on substrates.

Plastic materials, such as polycarbonate (PC) and polymethylmethyacrylate (PMMA), are nowadays used in many application areas such as automotive, constructions, electronics, headlamps, and sunroofs among the others.

Further development of their possibilities to enter new markets is hindered by the lack of surface hardness and abrasion resistance.

Other uses of the polymeric materials, such as glazing, decorative architectural panels and mirrors, are also limited because of this lack of abrasion resistance. In this sense a lot of work has been devoted to the development of coating to solve this issue, for instance it has been proposed to use scratch resistant coatings, such as silica-containing solutions and polysilicic acid fluorinated copolymer compositions. But these materials have found only limited commercial use because they are difficult to apply, poor in humidity resistance or expensive (U.S. Pat. No. 3,986,997).

Moreover those studies concerned film transparent in the UV region, more in particular at wavelength higher close to 287 nm which causes a breakdown in carbonate linkages accompanied by liberation of carbon monoxide and carbon dioxide and depolymerization of the substrate. Ultraviolet radiation from the sun can reach the surface of a substrate coated with an ultraviolet radiation-transparent coating and cause it to degrade. As a result, the protective coating loses adhesion and begins to flake off as the article weathers.

Another approach is that proposed by Ward Brown from Rohm and Haas Corp. US patent 2003/0134949 which describes the use of autoxidable alkoxysilane. Those alkoxisilane boost the resistance to weathering of plastic object and yet they do not provide enough radiation stability.

A transparent and abrasion resistant coating compositions is described in the U.S. Pat. No. 4,500,669 with is made of a colloidal dispersion of metals, alloy, salts and oxides, but does not provide solution to damage caused by UV radiation.

Very few authors have tried to combine Sol-gel techniques and UV stability in order to obtain coating systems that are at the same time abrasion resistant and UV stable.

Moreover, it is clear that it would be a perfect match to have a glassy coating which combines the outstanding properties of glass such as electrical conductivity and thermal stability (e.g., polycarbonate T_{g}=145° C.) with some UV protection.

The subject of the invention is a process for making a vitreous coating on plastic substrates such as polycarbonate, polymethylmetacrylates and polyolefins among the others.

The technology used is the sol-gel techniques already described in our previous patent WO 2004/007384.

The sol-gel techniques for making coatings consists in making a suspension in alcoholic medium by mixing the component at room temperature, let the suspension gelling under controlled conditions and finally there is the drying step which could be considered like a curing step.

In reality this is a very general procedure because every type of coating requires a specific preparation process i.e. suspension composition, application of the suspension on the substrate (dip or spray or spin coating techniques) gelling conditions (T) and the drying procedure, solvent evaporation, T of curing, rate of drying.

The literature describes the use sol -gel techniques-based coating for several supports but the industrialisation of such methods have been always seen as problematic because of the high temperature required for curing, see for instance the U.S. Pat. Nos. 6,017,389, 6,130,152 and the Italian patent NO98 A00004.

The subject of the invention is a method to manufacture sol-gel based coating with abrasion resistance and UV stability properties which requires mild conditions for the manufacturing and the application on the substrate.

The subject of the invention is a process for the preparation of hydrophobic transparent films on substrates comprising the following steps:
preparation of a solution in a solvent of one or more alcoxides corresponding to the formula:

Xm-Me-(OR)n-m (I)

where Me is silicon; n is the valence of Me;

X is R1 or OR1, with R1 equal or different from R,

m is either zero or an integer number equal to or lower than 3;

R and R1 are hydrocarbon radicals with a number of carbon atoms equal to or lower than 12;
hydrolysis of the obtained solution in the presence of a catalyst;
addition of a hydrophobic agent;
optional addition of a compound with ultraviolet radiation absorbing properties
optional addition of a hydrophobic agent
optional addition of a antistatic and reducing reflectance agent
optional addition of a compound with photocatalytic properties
optional addition of a polymer as thickening agent
optional addition of a compound with antibacterial properties
deposition of the sol on the substrate of interest;
final drying and curing of the coating;

The solution obtained by hydrolysis of a solution in an inorganic solvent of one or more alkoxides responding to the formula (I) can be a stable colloidal solution.

The alkoxide preferably can be selected among tetramethylorthosilane, tretraethylorthosilane, tetraethoxyorthosilicate, tetrapropylorthosilicates, tetrabutylorthosilicate, ethyltriethoxysilane, methyltrimethoxysilane, methyltriethoxysilane or a mixture of the same.

The alkoxide solution where the organic solvent preferably can be chosen among acetone, tetrahydrofurane, dioxane and more preferably ethanol. The concentration of the solution can be in a percentage 10 and 55 by weight.

The compound with ultraviolet radiation absorbing property can selected from the group of benzotriazoles, the s-triazines, the oxanilides, the salicylates, the hydroxybenzophenones, the benzoates and the α-cyanoacrylates and inorganic molecules from the group TiO₂ and ZnO. It can be in a percentage 0.7 and 8 by weight.

The compound with hydrophobic agent can be a tetrafluoroctyltriethoxysilane. It can be in a percentage 0.1 and 6 by weight.

The compound with antistatic and reducing reflectance properties can be selected from the group of tin oxide, indium oxide, antimony tin oxide and titanium oxide. It can be in a percentage between 0.1 and 5 by weight.

The polymer with thickening properties can be selected from the group polystyrene, polyvinylalcohol, polyvinylacetate, polyethyleneglycole with molecular weight between 300 and 12000. The percentage can be between 0.5% to 10%, more preferably between 2 and 5% by weight.

The compound with photocatalytic properties can be selected from the group titanium dioxide, zinc oxide. It can be in a percentage between 0.5% and 7% by weight.

The compound with antibacterial properties can be AgO. It can be in percentage between 0.05 and 5 by weight.

The alkoxide solution or mixture in the solvent can be between 20% and 60% by weight.

The hydrolysis of the alkoxide can be performed by addition of a controlled quantity of water.

The molar ratio H₂O/Me can be between 0.3 and 6, preferably between 1.5 and 3.

The catalyst can be an acid selected among the mineral acid and organic acids with Ka between 0.1 and 3.

The drying temperature can be between 60 and 200° C.

The process concerns the preparation of a sol in solution of one or more alkoxides having the formula:

Xₘ-Me-(OR)ₙ₋ₘ

where Me is silicon, n is the valence of Me

X is R₁ or OR₁,X is R₁ or OR₁, where R₁ is equal or different from R, and m is an integer number of either zero or an integer number equal or inferior to 3,

R and R1 are hydrocarbon moieties with atom carbon chain length up to 12.

According to the invention it has been found that the alkoxide is miscible in solvent such as tetrahydrofurane, acetone and ethanol.

In accordance with the invention, a hydrophobic agent and functional additive are employed to chemically modify the surfaces. Hydrophobic agents conventionally used in the art may be silicon-based agents including siloxane, silane or silicon; F-based hydrophobic agents such as fluorosilanes, fluoroalkylsilanes (FAS), polytetrafluoroethylene, polytrifluoroethylene, polyvinylfluoride, or functional fluoroalkyl compounds, preferred hydrophobic agent is Dynasil F8261 supplied by Degussa AG Germany.

Afterwards the hydrolysis is initiated by adding water solution of an acid. The hydrolysis reaction is exothermic and for this reason the temperature raises some degrees, the increase is very much dependent on batch size and hydrolysis conditions. As the maximal temperature is reached the organic UV-filter is added to the batch under stirring.

As soon as the solution has been prepared it is applied to a substrate by, for instance, dip coating or spin coating method.

Unlike the process described in the already cited U.S. Pat. No. 6,017,389 the obtained solution is not refluxed for 1.5 hours but just stirred for few minutes, furthermore the molar ratio TEOS:Ethanol is always bigger than 1.2 whereas in the cited patent is lower. In the same patent it is claimed that the porous layer of silica is obtained in two steps process which concern two different solvents The process that the authors are here reporting is also different from what has been reported in the U.S. Pat. No. 3,986,997 (example 6) in which is reported a multi-steps process to manufacture the sol using a bigger than 1 molar ratio TEOS/Ethanol, whereas the authors suggest to use more ethanol than TEOS.

The mentioned UV-filter could be any of hydrobenzophenone, hydroxybenzotriazol or hydroxyl-phenyl-triazine derivatives EP 0 818 450.

Afterwards there is the gelletion step which is catalysed by organic or inorganic acid.

Deposition of the sol on the substrate which can be done either just after hydrolysis or while later just before the gelation takes place.

The substrate can be any known polymer.

In a preferred form of the invention the substrate can be selected from the group of polycarbonate, polymethylmetacrylate, polystyrene, polyethylene, polypropylene, polyvinylchloride, polyethylenephthalate, ABS, CR39 or nylon.

Preferred the substrate can be polycarbonate (PC), polystyrene or polymethylmetacrylate (PMMA).

The final step is the curing or drying of the sol already on the substrate surface. It is important that the temperature of curing is higher than 70° C., preferably 80 to 120° C. The curing can be done either in an oven where air is blown at high efficiency or under IR lamps or in any industrial method used to cure polymeric coatings, whereby the temperature is to be adapted to the substrate. I.e. for PMMA is better to have 80° C. while for PC is better to have 110° C.

The formulation is in general terms fixed by the height of the layer to be obtained. For the PC the thickness is 800 nanometer while for PMMA is 500 nanometer.

### EXAMPLES

### Example 1

A 1 l round flask containing a magnetic stir bar is loaded with 261.8 g of ethanol and 197.28 g of tetraethoxysilane supplied by Degussa AG under the trade name Dynasil (TEOS).

At room temperature and under constant and strong stirring are then added very slowly 39.72 g of HCl 1M. The temperature increase due to the hydrolysis reaction is of 20° C.

The solution so obtained is then applied by dip coating (dipping speed 0.39 cm/s) on rectangular polycarbonate plate (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | F | 72 | Fail | 23.0 |
| with coating | | | | |

Chemical stability towards butylacetate, acetone and tetrahydrofurane of the coated polycarbonate plate is unchanged when compared to the uncoated polycarbonate.

The hardness is measured according to method ASTM D336 by using a series of pencils with different hardness from 8B (the most soft) to 8H (the hardest).

The coating adhesion was evaluated by grid adhesion test based on JIS K5400. A one-hundred-section grid was cut on the coated surface. Adhesive tape was applied to the grid, and then sharply removed (vertical to the surface). “Pass” means that no damages have been observed, conversely, “Fail” means at least one section damaged.

Surface roughness is determined by profilometer Taylor Mod. 222.

Chemical stability of coated material of the coated polycarbonate is checked by dipping the plate into pure solvent and checking visually if the solvent has changed the aesthetic of surface. Solvents tested: acetone, butylacetate and tetrahydrofurane.

The uncoated polycarbonate is not stable in those solvents.

### Example 2

A 1 l round flask containing a magnetic stir bar is loaded with 254.17 g of ethanol and 191.53 g of tetraethoxysilane supplied by Degussa AG under the trade name Dynasil (TEOS).

At room temperature and under constant stirring are then added very slowly 39.72 g of HCl 1M. The temperature increase due to the hydrolysis reaction is of 20° C. When the temperature reached the maximum 14.56 g of Tinuvil 1130 Bis(-β-[3-(2-H-Benzotriazole-2-yl)-4-hydroxy-5-terbutylphenil]-propionic acid-polyethylenglycol) 300-ester supplied by Ciba have been added to the solution.

The mixture so obtained is then applied by dip coating (dipping speed 0.39 cm/s) on rectangular polycarbonate plate (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | 3H | 9 | Pass | 12.6 |
| with coating | | | | |

Chemical stability towards butylacetate, acetone and tetrahydrofurane of the coated polycarbonate plate is improved when compared to the uncoated polycarbonate plate. The coated polycarbonate under visual inspection did not change the surface appearance.

### Example 3

A 1 l round flask containing a magnetic stir bar is loaded with 261.09 g of ethanol, 176.79 g of tetraethoxysilane supplied by Degussa AG under the trade name Dynasil A (TEOS) and 11.34 triethoxyphenylsilane supplied by Degussa AG Germany under the trade name Dynasil 9265.

At room temperature and under constant stirring are then added very slowly 40.78 g of HCl 1M. The temperature increase due to the hydrolysis reaction is of 20° C.

The mixture so obtained is then applied by dip coating (dipping speed 0.39 cm/s) on rectangular polycarbonate plate (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | H | 70 | Pass | 18.0 |
| with coating | | | | |

Chemical stability towards butylacetate, acetone and tetrahydrofurane of the coated polycarbonate plate is unchanged when compared to the uncoated polycarbonate plate.

### Example 4

A 1 l round flask containing a magnetic stir bar is loaded with 253.48 g of ethanol, 181.34 g of tetraethoxysilane supplied by Degussa AG under the trade name Dynasil A (TEOS) and 11.01 g of triethoxyphenylsilane supplied by Degussa AG Germany under the trade name Dynasil 9265.

At room temperature and under constant stirring are then added very slowly 39.59 g of HCl 1M. The temperature increase due to the hydrolysis reaction is of 20° C. When the temperature reached the maximum 14.56 g of Tinuvil 1130 Bis(-β-[3-(2-H-Benzotriazole-2-yl)-4-hydroxy-5-terbutylphenil]-propionic acid-polyethylenglycol) 300-ester supplied by Ciba have been added to the solution.

The mixture so obtained is then applied by dip coating (dipping speed 0.39 cm/s) on rectangular polycarbonate plate (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | 4H | 8 | Pass | 9.6 |
| with coating | | | | |

Chemical stability towards butylacetate, acetone and tetrahydrofurane of the coated polycarbonate plate is improved when compared to the uncoated polycarbonate plate. The coated polycarbonate under visual inspection did not change the surface appearance.

### Example 5

A 1 l round flask containing a magnetic stir bar is loaded with 253.48 g of ethanol, 181.34 g of tetraethoxysilane supplied by Degussa AG under the trade name Dynasil A (TEOS) and 11.01 g of triethoxyphenylsilane supplied by Degussa AG Germany under the trade name Dynasil 9265.

At room temperature and under constant stirring are then added very slowly 39.59 g of HCl 1M. The temperature increase due to the hydrolysis reaction is of 20° C. When the temperature reached the maximum 14.56 g of Tinuvil 1130 Bis(-β-[3-(2-H-Benzotriazole-2-yl)-4-hydroxy-5-terbutylphenil]-propionic acid-polyethylenglycol) 300-ester supplied by Ciba have been added to the solution.

The mixture so obtained is then applied by dip coating (dipping speed 0.39 cm/s) on rectangular polymethylmetacrylate plate (PMMA) (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 21 | NA | 17.5 |
| untreated | | | | |
| Polycarbonate | 4H | 3 | Pass | 12 |
| with coating | | | | |

Chemical stability towards dichloromethane of the coated PMMA plate is improved when compared to the uncoated PMMA plate. The coated polymethylmetacrylate plate under visual inspection did not change the surface appearance.

### Example 6

A 1 l round flask containing a magnetic stir bar is loaded with 250.98 g of ethanol, 181.34 g of tetraethoxysilane supplied by Degussa AG under the trade name Dynasil A (TEOS), 11.01 g of triethoxyphenylsilane supplied by Degussa AG Germany under the trade name Dynasil 9265 and 2.5 g Dynasil F8261 (tetrafluoroctyltriethoxysilane) supplied by Degussa AG.

At room temperature and under constant stirring are then added very slowly 39.59 g of HCl 1M. The temperature increase due to the hydrolysis reaction is of 20° C. When the temperature reached the maximum 14.56 g of Tinuvil 1130 Bis(-β-[3-(2-H-Benzotriazole-2-yl)-4-hydroxy-5-terbutylphenil]-propionic acid-polyethylenglycol) 300-ester supplied by Ciba have been added to the solution.

The mixture so obtained is then applied by dip coating (dipping speed 0.39 cm/s) on rectangular polycarbonate plate (PC) (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | 2H | 11 | Pass | 6.1 |
| with coating | | | | |

Chemical stability towards butylacetate, acetone and tetrahydrofurane of the coated percarbonate plate is improved when compared to the uncoated percarbonate plate. The coated polycarbonate under visual inspection did not change the surface appearance.

### Example 7

A 1 l round flask containing a magnetic stir bar is loaded with 250.98 g of ethanol, 181.34 g of tetraethoxysilane supplied by Degussa AG under the trade name Dynasil A (TEOS), 11.01 g of triethoxyphenylsilane supplied by Degussa AG Germany under the trade name Dynasil 9265 and 2.5 g tin oxide (ITO).

At room temperature and under constant stirring are then added very slowly 39.59 g of HCl 1M. The temperature increase due to the hydrolysis reaction is of 20° C. When the temperature reached the maximum 14.56 g of Tinuvil 1130 Bis(-β-[3-(2-H-Benzotriazole-2-yl)-4-hydroxy-5-terbutylphenil]-propionic acid-polyethylenglycol) 300-ester supplied by Ciba have been added to the solution.

The mixture so obtained is then applied by dip coating (dipping speed 0.39 cm/s) on rectangular polycarbonate plate (PC) (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | H | 11 | Pass | 21 |
| with coating | | | | |

The obtained coating has a porous aspect and is characterized by antireflecting properties such as minimum reflectance measured in the range 450-750 nm.

### Example 8

A 1 l round flask containing a magnetic stir bar is loaded with 254.17 g of ethanol and 191.53 g of tetraethoxysilane supplied by Degussa AG under the trade name Dynasil (TEOS).

At room temperature and under constant stirring are then added very slowly 39.72 g of HCl 1M. The temperature increase due to the hydrolysis reaction is of 20° C. When the temperature reached the maximum 14.56 g of Tinuvil 1130 Bis(-β-[3-(2-H-Benzotriazole-2-yl)-4-hydroxy-5-terbutylphenil]-propionic acid-polyethylenglycol) 300-ester supplied by Ciba have been added to the solution with a solution made of 14 g THF plus 14 g of polystyrene.

The mixture so obtained is then applied by dip coating (dipping speed 0.39 cm/s) on rectangular polycarbonate plate (10 cm length, 15 cm with, 0.3 cm thickness). The plate is then dried for 12 hours at 120° C. in an oven. The plate so obtained has undergone characterisation tests:

| | Hardness | | | |
|---|---|---|---|---|
| | according | | Grid | Surface |
| | to ASTM | Transmittance | adhesion | roughness |
| | method | at 300 nm (%) | test | RA (nm) |
| Polycarbonate | F | 71 | NA | 25.7 |
| untreated | | | | |
| Polycarbonate | H | 9 | Pass | 11 |
| with coating | | | | |

The thickness of the coating is 3 micron whereas the same formulation without polymer has a thickness of 0.8 micron (see example 3).

Based on the obtained results one can infer that the basic coating formulation solvent, TEOS and acid can be strongly improved, performance-wise, by adding either the UV filter or the modified the ethoxysilane.

Without wishing to be bound to any theory it is believed that both component work as plasticisers making the glassy coating less fragile.

In the example 6 it has been listed also the Dynasil F8261 as agent for better hydrophobic effect.

These coatings are useful in a variety of substrate, here have been listed only PC and PMMA but in reality the process is suitable also, without limiting the scope of this invention, for polyethylene, polypropylene, polyvinylchloride, polyethylene-etereftalate, acrylnitrilebutadienstyrene (ABS), allyldiglycolcarbonate (CR39) and nylon.

1. A process for the preparation of hydrophobic transparent films on substrates with the following steps:
preparation of a solution in a solvent of one or more alkoxides corresponding to the formula:
Xm-Me-(OR)ₙ₋ₘ (I)
where Me is silicon; n is the valence of Me;
X is R1 or OR1, with R1 equal or different from R, m is either zero or an integer number equal to or lower than 3;
R and R1 are hydrocarbon radicals with a number of carbon atoms equal to or lower than 12;
hydrolysis of the obtained solution in the presence of a catalyst;
addition of a hydrophobic agent
optional addition of a compound with ultraviolet radiation absorbing properties;
optional addition of a antistatic and reducing reflectance agent;
optional addition of a compound with photocatalitic properties;
optional addition of a polymer as thickening agent;
optional addition of a compound with antibacterial properties;
deposition of the sol on the substrate of interest;
final drying and curing of the coating.

2. The process for the preparation of transparent films according to claim 1 in which the alkoxide is selected from the group consisting of tetramethylorthosilane, tetraethylorthosilane, tetraethoxyorthosilicate, tetrapropylorthosilicates, tetrabutylorthosilicate, thyltriethoxysilane, methyltrimethoxysilane, methyltriethoxysilane, and a mixture thereof.

3. The process for the preparation of transparent films according to claim 1 where the organic solvent solution of the alkoxide is selected from the group consisting of acetone, tetrahydrofurane, dioxane and ethanol.

4. The process for the preparation of transparent films according to claim 1 where the compound with ultraviolet radiation absorbing property is selected from the group consisting of a benzotriazole, a s-triazine, an oxanilide, a salicylate, a hydroxybenzophenone, a benzoate, an α-cyanoacrylate, TiO₂ and ZnO.

5. The process for the preparation of transparent films according to claim 1 where the compound with antistatic and reducing reflectance properties is selected from the group consisting of tin oxide, indium oxide, antimony tin oxide and titanium oxide.

6. The process for the preparation of transparent films according to claim 1 where the polymer with thickening properties is selected from the group consisting of polystyrene, polyvinylalcohol, polyvinylacetate, and a polyethyleneglycole with molecular weight between 300 and 12000.

7. The process for the preparation of transparent films according to claim 1 where the compound with photocatalytic properties is selected from the group consisting of titanium dioxide and zinc oxide.

8. The process for the preparation of transparent films according to claim 1 where the compound with antibacterial properties is Ago.

9. The process for the preparation of films according to claim 1 where the alkoxide solution or mixture in the solvent is between 20% and 60% by weight.

10. The process for the preparation of films according to claim 1 where the hydrolysis of the alkoxide is performed by addition of a controlled quantity of water.

11. The process for the preparation of films according to claim 10 where the molar ratio H₂O/Me is between 0.3 and 6.

12. The process for the preparation of films according to claim 1 where the catalyst is an acid selected from the group consisting of mineral acid and organic acids with Ka between 0.1 and 3.

13. The process for the preparation of films according to claim 1 where the drying temperature is between 60 and 200° C.

14. The process for the preparation of transparent films according to claim 1, wherein the hydrophobic agent is tetrafluoroctyltriethoxy-silane.

15. A process for making a hydrophobic transparent film on a substrate comprising:
hydrolyzing, in the presence of a catalyst, a solution comprising at least one alkoxide represented by formula (I):
Xm-Me-(0R)ₙ₋ₘ (I)
where
Me is silicon,
n is the valence of Me,
X is R1 or OR1, with R1 equal or different from R,
m is either zero or an integer number equal to or lower than 3,
each of R and R1 is, independently, a hydrocarbon radical with a number of carbon atoms equal to or lower than 12;
adding at least one hydrophobic agent to form a sol;
depositing said sol on said substrate; and
final drying and curing of the coating.

16. The process according to claim 15, further comprising at least one of:
adding a compound with ultraviolet radiation absorbing properties;
adding an antistatic and reducing reflectance agent;
adding a compound with photocatalitic properties;
adding a polymer as thickening agent; and
adding of a compound with antibacterial properties.
